(19) United States
(12) Patent Application Publication
(10) Pub. No.: US 2014/0214832 A1
(43) Pub. Date: Jul. 31, 2014

(54) INFORMATION GATHERING VIA CROWD-SENSING

(71) Applicant: INTERNATIONAL BUSINESS MACHINES CORPORATION, Armonk, NY (US)

(72) Inventors: Vikrant Nandakumar, Banglore (IN); Naveen K. Prathapaneni, Hyderabad (IN); Nithya Rajamani, Hyderabad (IN); L. Venkata Subramaniam, Gurgaon (IN)

(73) Assignee: INTERNATIONAL BUSINESS MACHINES CORPORATION, Armonk, NY (US)

(21) Appl. No.: 13/755,767

(22) Filed: Jan. 31, 2013

(51) Int. Cl. G06F 17/30

(52) U.S. Cl. CPC G06F 17/3071
USPC 707/737

(57) ABSTRACT

Methods and arrangements for gathering and managing crowd-sourced information. An event is identified using crowd-sourced information, and component parts of the event are identified using the crowd-sourced information. Information missing from the event is identified using the crowd-sourced information. Individuals associated with the event are identified, and additional crowd-sourced information on the event is harvested from the individuals.

### BACKGROUND

Generally, in crowd-sensing tasks, it can be important to engage participants to ensure that there is a regular flow of useful information on events of interest. In participatory crowd sensing, where participants opt in to provide information (such as information regarding events in a city), there tends to be a lack of direction and coordination that might otherwise be helpful in clarifying aspects of an event about which there is an information need. Particularly, since such events can often be composed of several aspects or parts, a lack of coordination in bringing together and reconciling these can make it difficult, if not impossible, to provide a comprehensive picture.

### BRIEF SUMMARY

In summary, one aspect of the invention provides a method of gathering and managing crowd-sourced information, the method comprising: receiving, at an electronic device, crowd-sourced information; and utilizing a processor to execute computer code configured to perform the steps of: identifying an event using the crowd-sourced information; identifying component parts of the event using the crowd-sourced information; identifying missing information from the event using the crowd-sourced information; and identifying individuals associated with the event, and harvesting from the individuals additional crowd-sourced information on the event.

Another aspect of the invention provides an apparatus for gathering and managing crowd-sourced information, the apparatus comprising: at least one processor; and a computer readable storage medium having computer readable program code embodied therewith and executable by the at least one processor, the computer readable program code comprising: computer readable program code configured to identify an event using crowd-sourced information; computer readable program code configured to identify component parts of the event using the crowd-sourced information; computer readable program code configured to identify missing information from the event using the crowd-sourced information; computer readable program code configured to identify individuals associated with the event; and computer readable program code configured to harvest from the individuals additional crowd-sourced information on the event.

An additional aspect of the invention provides a computer program product for gathering and managing crowd-sourced information, the computer program product comprising: a computer readable storage medium having computer readable program code embodied therewith, the computer readable program code comprising: computer readable program code configured to identify an event using crowd-sourced information; computer readable program code configured to identify component parts of the event using the crowd-sourced information; computer readable program code configured to identify missing information from the event using the crowd-sourced information; computer readable program code configured to identify individuals associated with the event; and computer readable program code configured to harvest from the individuals additional crowd-sourced information on the event.

A further aspect of the invention provides a method comprising: receiving messages; parsing the messages; after parsing the messages, designating an event class related to the messages; identifying component parts of the event class; for at least one message of the received messages, assigning at least a portion of the at least one message to a corresponding part of the event class; determining parts of the event class to which at least one portion of at least one message has not been assigned; identifying one or more actors associated with the event based on the received messages; and requesting information from the one or more actors corresponding to at least one of the parts of the event class to which at least one portion of at least one message has not been assigned.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 schematically illustrates a crowd-sourcing example.

FIG. 2 schematically illustrates a “completion of the picture” with regard to the example of FIG. 1.

FIG. 3 schematically illustrates a method flow.

FIG. 4 schematically illustrates a general flow of steps.

FIG. 5 schematically illustrates a provision of freeform input.

FIG. 6 schematically illustrates an event classification step.

FIG. 7 schematically illustrates an event model and associated parts identification.

FIG. 8 schematically illustrates an event completion step.

FIG. 9 schematically illustrates an arrangement for directed input.

FIG. 10 sets forth a process more generally for gathering and managing crowd-sourced information

FIG. 11 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The description now turns to the figures. The illustrated embodiments of the invention will be best understood by reference to the figures. The following description is intended only by way of example and simply illustrates certain selected exemplary embodiments of the invention as claimed herein.

It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

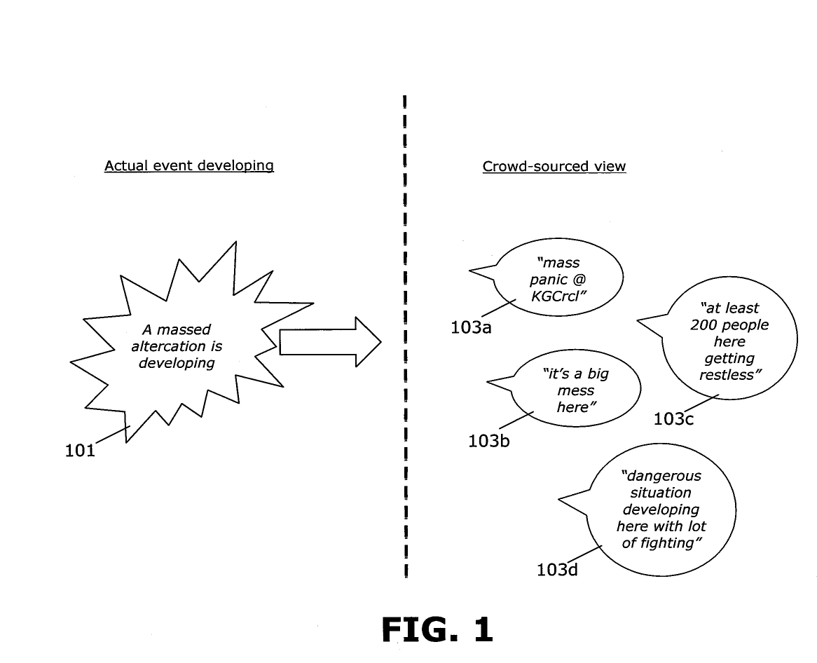

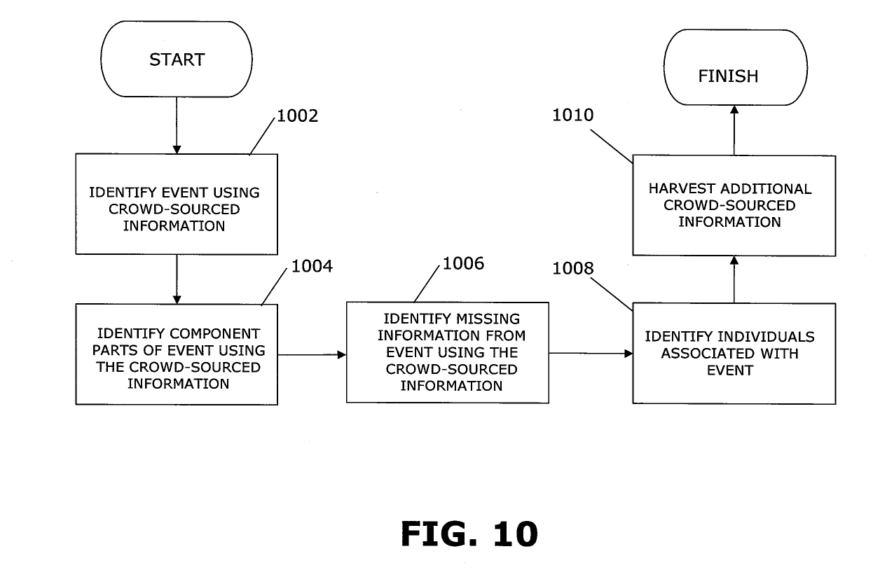

To facilitate easier reference, in advancing from FIG. 1 to and through FIG. 10, a reference numeral is advanced by a multiple of 100 in indicating a substantially similar or analogous component or element with respect to at least one component or element found in at least one earlier figure among FIGS. 1-10.

FIG. 1 schematically illustrates a crowd-sourcing example, in accordance with at least one embodiment of the invention. As shown, in response to an actual developing event (e.g., a street altercation, such as a massed street altercation) 101, a crowd-sourced response may take place wherein several messages 103a-103d may be transmitted via any of a variety of messaging or social networking arrangements that permit public messaging.

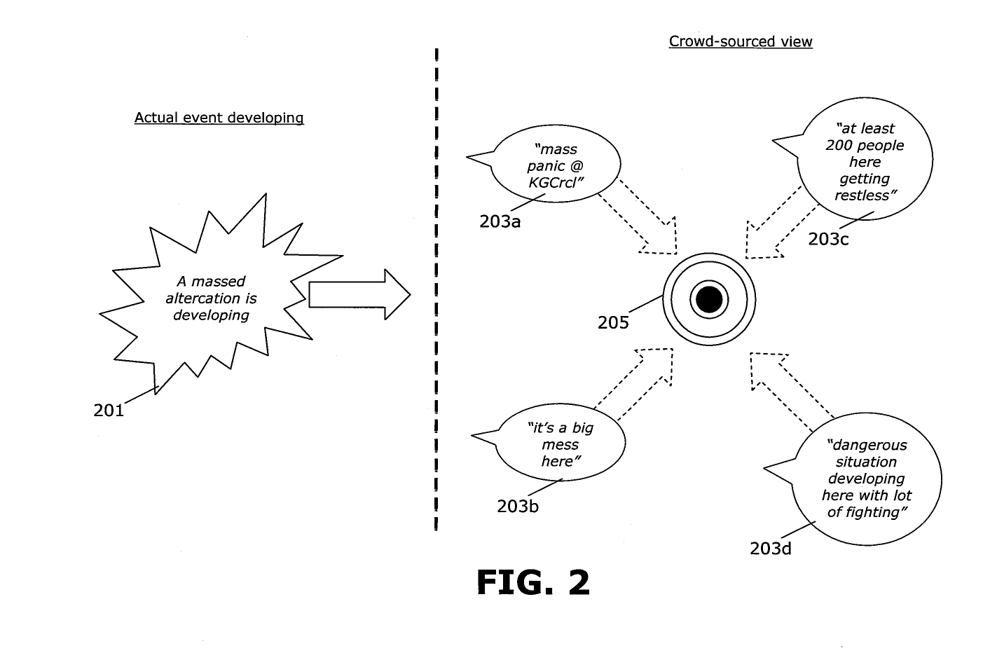

FIG. 2 schematically illustrates a “completion of the picture” with regard to the example of FIG. 1, in accordance with at least one embodiment of the invention. Each person sees a part of the big picture. Particularly, inasmuch as transmissions 203a-d may originate from a variety of individuals or sources, with respect to a variety of messaging or social networking arrangements, broadly contemplated herein are methods and arrangements for collecting and consolidating such transmissions at a common location or focal point 205, whereupon additional interaction may take place with individuals or sources to piece together a more accurate and complete view of the event 201. As such, and in a manner described more fully below, individuals or sources (e.g., within a “crowd” or common grouping that can be defined by parameters such as proximity to the event 201) can be guided to collect helpful information to “complete the picture”.

Generally, then, in accordance with at least one embodiment of the invention, an objective is to form a complete picture of a developing event via defining the parts of an event, and defining methods to crowd-source these parts to complete the picture. As such, four main method steps are contemplated. In event detection, based on undirected crowd-sourced inputs, a detection is made that an event is developing (e.g., “accident on main st.”, “car pile up”, “car overturned”). In event classification, a semantic model is determined for this developing event (e.g., “road accident”). In parts identification, parts are identified to complete the semantic model (e.g., type of accident, number/type of vehicles involved, injury type, number of injured, traffic disruption status, emergency services invoked). In event completion, actors are identified in the vicinity along with their current state, and they are asked for information on the missing parts (e.g., how many people are injured).

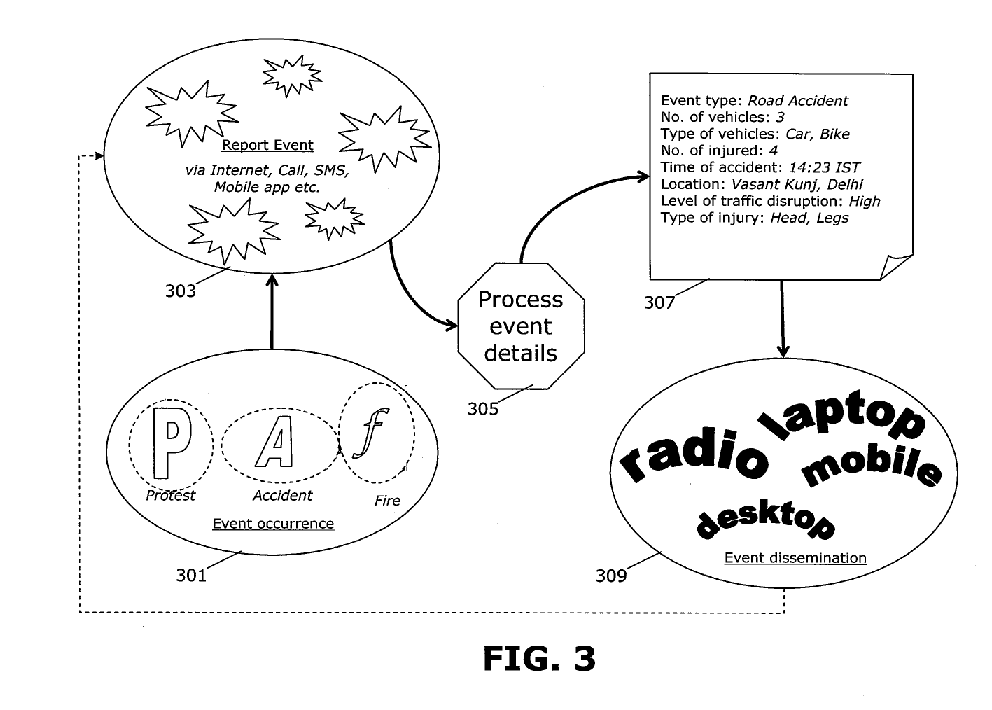

As such, FIG. 3 schematically illustrates a method flow in accordance with at least one embodiment of the invention. As shown, an event 301 may occur which is then reported (303) by individuals or sources via arrangements such as internet, a mobile phone call, SMS text, a mobile phone application or any of a wide variety of other suitable arrangements. Input is then received at a hub or central location 305 and, based on the information received, the event is classified (307) in terms of different identifying criteria. Information about the event is then disseminated anew (309) (e.g., to radios, laptops, mobile phones, desktop computers, etc.) and, in a manner described more fully below, is directed as such to individuals (which may include some or all of the same reporting individuals at 303) for the purpose of receiving further input on the event, to itself then be processed anew (305).

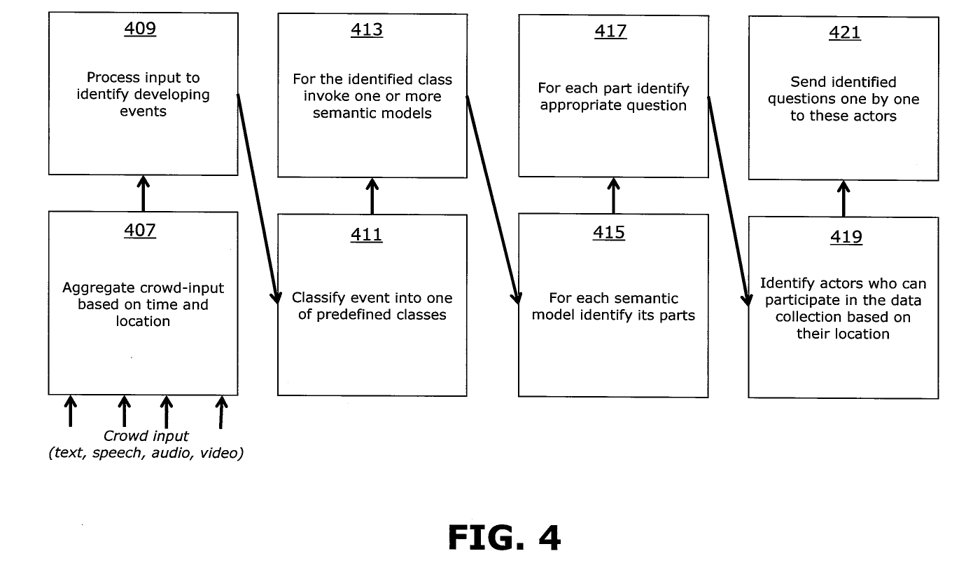

FIG. 4 schematically illustrates a general flow of steps, in accordance with at least one embodiment of the invention. “Crowd” input, or input from individuals or sources, is received and aggregated (407), including a classification based on time and location. The input is then processed to identify developing events (409). The event is then classified into one of several predefined classes (e.g., accident, fire) (411) and, for the identified class, one or more semantic models (or “event model”, as described elsewhere herein) are invoked (413). Parts are identified for each semantic model (415), and then for each part at least one appropriate question is identified (417), and then actors are identified who can receive the question (419). The actors may include one or more of the originally submitting individuals or sources, or even individuals or sources who did not initially submit information. They may be identified on the basis of location, e.g., their proximity to the event in question. The actors can also be identified on a basis of something other than location. For example, actors could include people who are known to have dealt with a similar issue before and who may have other sources from whom they can confirm and provide information; in this vein, e.g., non-proximate actors could still provide input inasmuch as they may be near a TV or other media resource with a report on an event, based on which they can view or assimilate what is taking place and thereupon transmit their own input or observations. The identified questions are then sent to the actors (421); preferably, the questions are sent one at a time but could also be sent in groups.

In event detection, in accordance with at least one embodiment of the invention, “crowd” input can be via text, speech, audio, image or video. By way of an example, text can be processed to identify an event. Thus, for instance, keywords can be extracted (e.g., “car”, “accident”, “injury”) and then aggregated over multiple messages to detect that an event has occurred (e.g., which can involve many messages a crowd from a particular location mentioning the keywords “car” and “accident”). It is also possible for some members of the crowd to submit audio, images and video of the event either by themselves or with accompanying text explaining it. In such cases it is also possible to process the audio, images and video using audio processing, image processing or video processing respectively to ascertain the actual event.

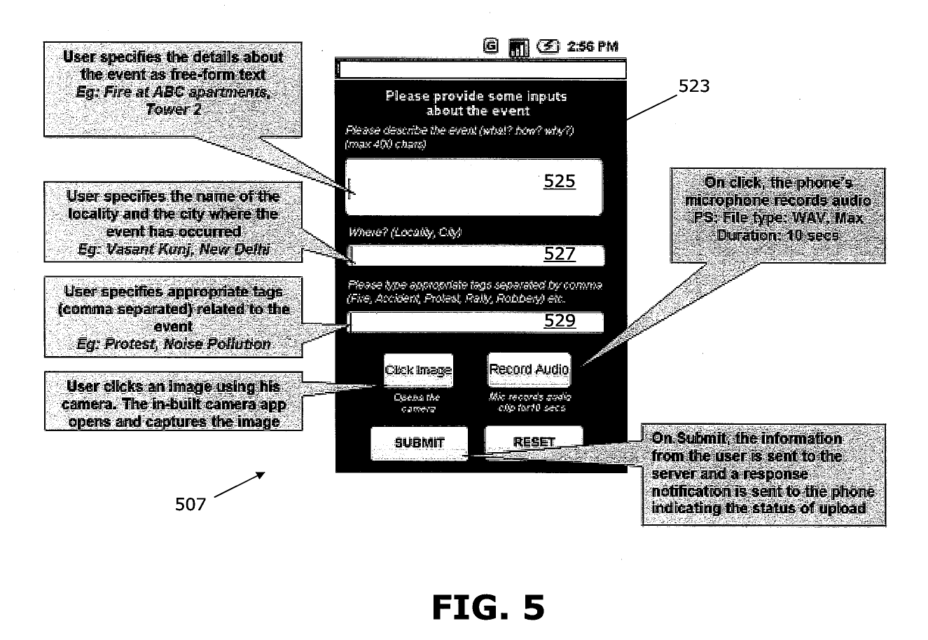

FIG. 5 schematically illustrates a provision (507) of freeform input from an individual or source, in accordance with at least one embodiment of the invention. Inputs can be taken, e.g., from mobile devices using mobile apps, or using internet, SMS, or phone calls, etc. The present example shows a mobile phone 523 which includes an app for permitting user input regarding an event. As such, in one field (525) a user may first specify details about the event as free-form text, then in another field (527) can specify the location (e.g., neighborhood and/or part of a city) where the event has occurred. In another field 529, the user may specify one or more tags related to the event; e.g., these could include “protest” or “noise pollution”, with different tags being separated by a comma. Then, the user could click to record an image using the phone camera and/or to record audio, wherein such visual or audio data can accompany the textual information submitted by the user (from fields 525/527/529). Clicking on “submit” ensures that information from the user is sent to a central location such as a server, and a response notification can be sent to the phone indicating the status of the upload. User inputs can be entered using dedicated channels like SMS, mobile apps, and other analogously functioning media. They can also be entered via more publically-based forums such as a microblogging medium, a general blog, a social network or other online (general or discussion) forum, whereupon user inputs can be extracted automatically (via essentially any suitable manner) and their information captured.

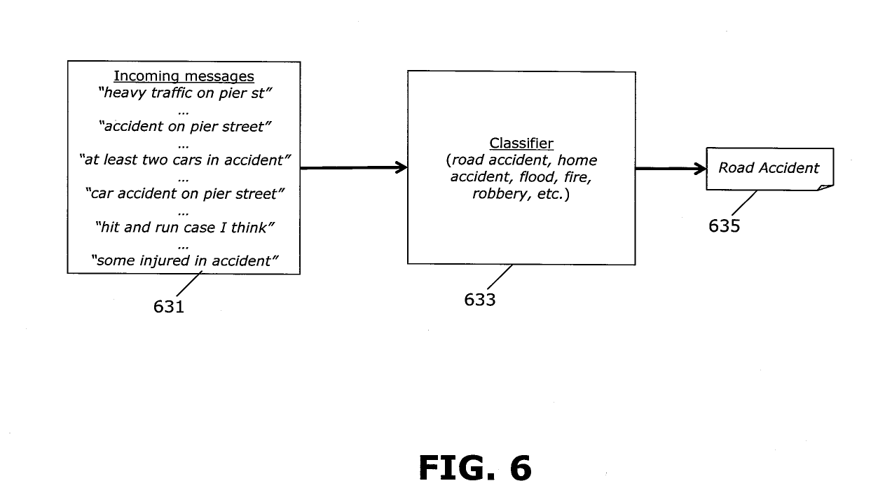

FIG. 6 schematically illustrates an event classification step, in accordance with at least one embodiment of the invention. Here, given a set of incoming messages 631, a rule-based or machine learning-based classifier 633 can be used to classify them into one of many known classes (e.g., road accident, home accident, flood, fire, massed altercation, etc.). (Essentially any suitable classifier may be employed here; illustrative examples may be found, e.g., in Aggarwal and Zhai, Mining Text Data [Kluwer Academic Publishers, 2012], Chapter 6 [pp. 163-223]: Aggarwal and Zhai, “A Survey of Text Classification Algorithms”.) In the present illustrative example, the classification of “road accident” is formed (635).

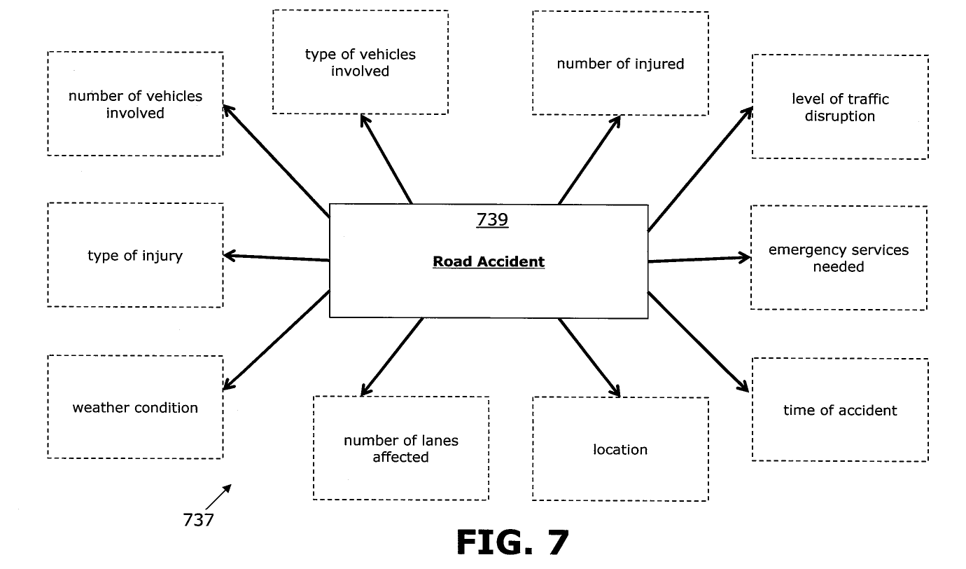

FIG. 7 schematically illustrates an event model and associated parts identification, in accordance with at least one embodiment of the invention. Illustrated here is an example of an event model 737 for a road accident, with a “hub” classification 739 and associated parts (items in dotted lines) that make up the model. Generally, event models can be predefined or they can be developed over time by learning important facets of information for a given event. Unknown events can be mapped to the nearest known predefined model based on the facets. Facet discovery, given a set of input messages, can be undertaken. Phrased more particularly, facet discovery relates to the process of identifying different facets of an event. For example, as shown in FIG. 7, a road accident can include facets that include the type of accident, the number of vehicles involved, whether there are injuries, etc. Thus, in facet discovery, user inputs are received and processed, whereupon an identification is made of those specific facets of an (identified) event that a user might be referring to.

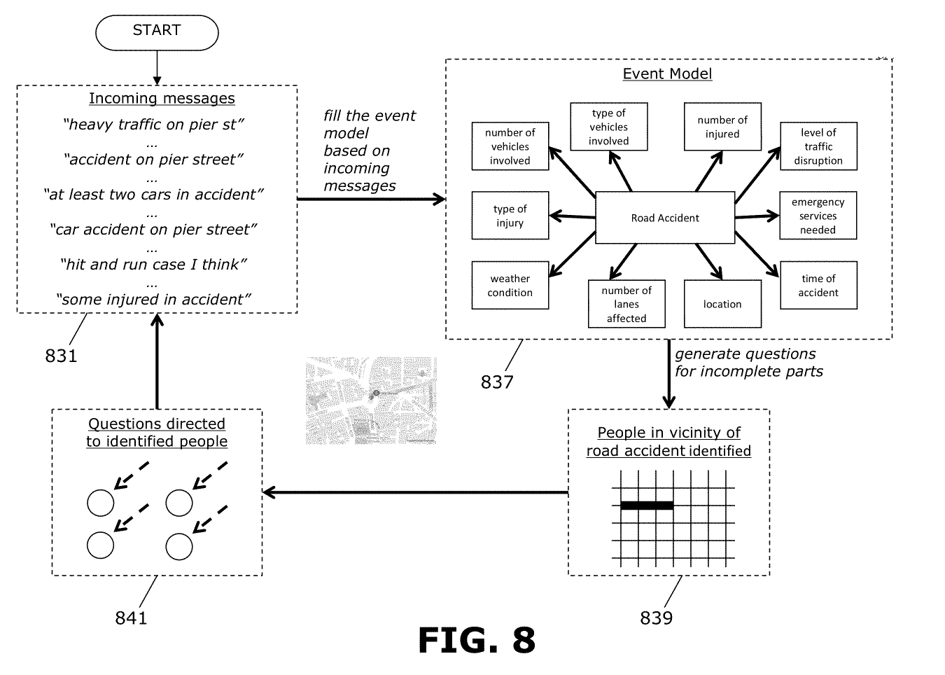

FIG. 8 schematically illustrates an event completion step, in accordance with at least one embodiment of the invention. As shown, crowdsourced messages 831 come in and, once the event is classified, the event model 837 is filled based on these. If incomplete parts in the model 837 are detected, then individuals or sources (“actors”) in the vicinity of the event (in the illustrative example, a road accident) are identified (839), and questions are directed to such identified people (841). Actors are then able to produce new messages, which can continue to fill the event model 837 as needed; this process can iterate until the model 837 is filled at or beyond a predetermined threshold (or becomes complete).

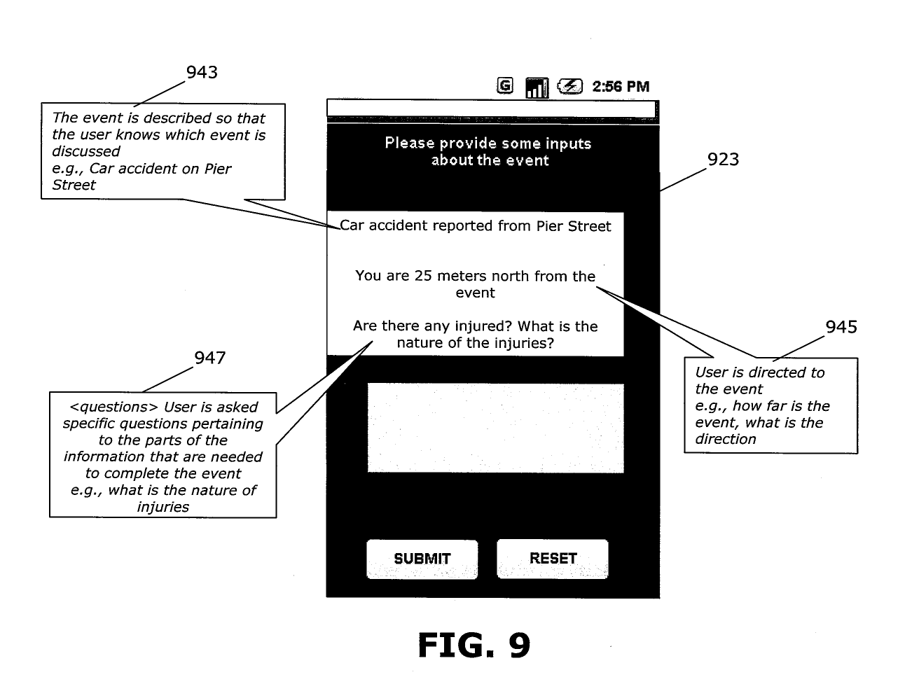

FIG. 9 schematically illustrates an arrangement for directed input, in accordance with at least one embodiment of the invention. As such, event completion can be undertaken by “filling in blanks” at a mobile phone 923 or other input device. Thus, relevant actors will have been identified for receiving one or more questions, as described heretofore. The event can be described to give context to the user (943). Thus, e.g., a current known location of the event can be given, along with a distance of the user from the event (945); further, currently known information about the event can be shared, etc. Questions are then directed to the user to seek missing information (947). Here, direct questions based on the event model can be employed.

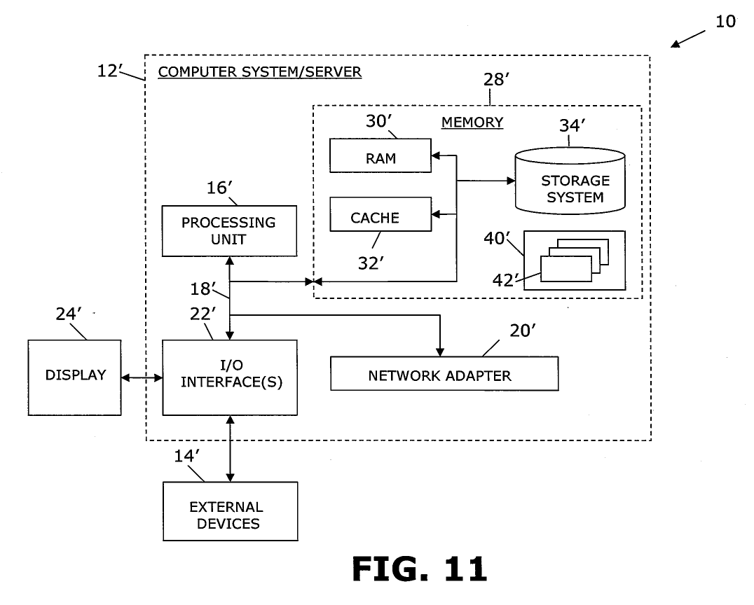

FIG. 10 sets forth a process more generally for gathering and managing crowd-sourced information, in accordance with at least one embodiment of the invention. It should be appreciated that a process such as that broadly illustrated in FIG. 10 can be carried out on essentially any suitable computer system or set of computer systems, which may, by way of an illustrative and non-restrictive example, include a system such as that indicated at 12′ in FIG. 11. In accordance with an example embodiment, most if not all of the process steps discussed with respect to FIG. 10 can be performed by way of a processing unit or units and system memory such as those indicated, respectively, at 16′ and 28′ in FIG. 11.

As shown in FIG. 10, in accordance with at least one embodiment of the invention, an event is identified using crowd-sourced information (1002), and component parts of the event are identified using the crowd-sourced information (1004). Information missing from the event is identified using the crowd-sourced information (1006). Individuals associated with the event are identified (1008), and additional crowd-sourced information on the event is harvested from the individuals (1010).

Referring now to FIG. 11, a schematic of an example of a cloud computing node is shown. Cloud computing node 10′ is only one example of a suitable cloud computing node and is not intended to suggest any limitation as to the scope of use or functionality of embodiments of the invention described herein. Regardless, cloud computing node 10′ is capable of being implemented and/or performing any of the functionality set forth hereinabove. In accordance with embodiments of the invention, computing node 10′ may not necessarily even be part of a cloud network but instead could be part of another type of distributed or other network, or could represent a stand-alone node. For the purposes of discussion and illustration, however, node 10′ is variously referred to herein as a “cloud computing node”.

In cloud computing node 10′ there is a computer system/server 12′, which is operational with numerous other general purpose or special purpose computing system environments or configurations. Examples of well-known computing systems, environments, and/or configurations that may be suitable for use with computer system/server 12′ include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12′ may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12′ may be practiced in distributed cloud computing environments where tasks are performed by remote processing devices that are linked through a communications network. In a distributed cloud computing environment, program modules may be located in both local and remote computer system storage media including memory storage devices.

As shown in FIG. 11, computer system/server 12′ in cloud computing node 10 is shown in the form of a general-purpose computing device. The components of computer system/server 12′ may include, but are not limited to, at least one processor or processing unit 16′, a system memory 28′, and a bus 18′ that couples various system components including system memory 28′ to processor 16′.

Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and includes both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

It should be noted that aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in at least one computer readable medium having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having at least one wire, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store, a program for use by, or in connection with, an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the invention may be written in any combination of at least one programming language, including an object oriented programming language such as Java®, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described herein with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture. Such an article of manufacture can include instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

What is claimed is:

1. A method of gathering and managing crowd-sourced information, said method comprising:
receiving, at an electronic device, crowd-sourced information; and
utilizing a processor to execute computer code configured to perform the steps of:
identifying an event using the crowd-sourced information;
identifying component parts of the event using the crowd-sourced information;
identifying missing information from the event using the crowd-sourced information; and
identifying individuals associated with the event, and harvesting from the individuals additional crowd-sourced information on the event.

2. The method according to claim 1, wherein said harvesting comprises sending directed questions to the individuals, the directed questions relating to the missing information.

3. The method according to claim 2, wherein said harvesting comprises receiving responses to the directed questions from the individuals.

4. The method according to claim 1, wherein said identifying of individuals comprises locating one or more individuals in proximity to the event.

5. The method according to claim 1, wherein said identifying of an event comprises classifying the event into a predefined class.

6. The method according to claim 5, wherein said identifying of an event comprises invoking a semantic model related to the predefined class.

7. The method according to claim 6, wherein said identifying of component parts comprises identifying event facets associated with the semantic model.

8. The method according to claim 7, wherein said identifying of missing information comprises identifying missing information associated with one or more event facets.

9. The method according to claim 8, wherein said harvesting comprises sending directed questions to the individuals, the directed questions relating to the missing information.

10. An apparatus for gathering and managing crowd-sourced information, said apparatus comprising:
at least one processor; and
a computer readable storage medium having computer readable program code embodied therewith and executable by the at least one processor, the computer readable program code comprising:
computer readable program code configured to identify an event using crowd-sourced information;
computer readable program code configured to identify component parts of the event using the crowd-sourced information;
computer readable program code configured to identify missing information from the event using the crowd-sourced information;
computer readable program code configured to identify individuals associated with the event; and
computer readable program code configured to harvest from the individuals additional crowd-sourced information on the event.

11. A computer program product for gathering and managing crowd-sourced information, said computer program product comprising:
a computer readable storage medium having computer readable program code embodied therewith, the computer readable program code comprising:
computer readable program code configured to identify an event using crowd-sourced information;
computer readable program code configured to identify component parts of the event using the crowd-sourced information;
computer readable program code configured to identify missing information from the event using the crowd-sourced information;
computer readable program code configured to identify individuals associated with the event; and
computer readable program code configured to harvest from the individuals additional crowd-sourced information on the event.

12. The computer program product according to claim 11, wherein said computer readable program code is configured to send directed questions to the individuals, the directed questions relating to the missing information.

13. The computer program product according to claim 12, wherein said computer readable program code is configured to receive responses to the directed questions from the individuals.

14. The computer program product according to claim 11, wherein said computer readable program code is configured to locate one or more individuals in proximity to the event.

15. The computer program product according to claim 11, wherein said computer readable program code is configured to classify the event into a predefined class.

16. The computer program product according to claim 15, wherein said computer readable program code is configured to invoke a semantic model related to the predefined class.

17. The computer program product according to claim 16, wherein said computer readable program code is configured to identify event facets associated with the semantic model.

18. The computer program product according to claim 17, wherein said computer readable program code is configured to identify missing information associated with one or more event facets.

19. The computer program product according to claim 18, wherein said computer readable program code is configured to send directed questions to the located individuals, the directed questions relating to the identified missing information.

20. A method comprising:
receiving messages;
parsing the messages;
after parsing the messages, designating an event class related to the messages;
identifying component parts of the event class;
for at least one message of the received messages, assigning at least a portion of the at least one message to a corresponding part of the event class;
determining parts of the event class to which at least one portion of at least one message has not been assigned;
identifying one or more actors associated with the event based on the received messages; and
requesting information from the one or more actors corresponding to at least one of the parts of the event class to which at least one portion of at least one message has not been assigned.
